(19) United States
(12) Patent Application Publication
(10) Pub. No.: US 2018/0370217 A1
(43) Pub. Date: Dec. 27, 2018

(54) PROCESSLESS LITHOGRAPHIC PRINTING PLATE

(71) Applicant: AGFA NV, Mortsel (BE)

(72) Inventors: Tim DESMET, Mortsel (BE); Sam VERBRUGGHE, Mortsel (BE)

(73) Assignee: AGFA NV, Mortsel (BE)

(21) Appl. No.: 16/062,161

(22) PCT Filed: Dec. 1, 2016
(86) PCT No.: PCT/EP2016/079425

§ 371 Date: Jun. 14, 2018

(30) Foreign Application Priority Data
Dec. 15, 2015 (EP) 15200010.5

(51) Int. Cl. B41C 1/10; H05H 1/24

(52) U.S. Cl. CPC B41C 1/1066; H05H 1/2475; B41C 1/1033

(57) ABSTRACT

A method for making a lithographic printing plate by direct-to-plate recording includes the step of image-wise deposition of a hydrophobic coating by microplasma onto a hydrophilic support or a support provided with a hydrophilic layer.

### CROSS REFERENCE TO RELATED APPLICATIONS

This application is a 371 National Stage Application of PCT/EP2016/079425, filed Dec. 1, 2016. This application claims the benefit of European Application No. 15200010.5, filed Dec. 15, 2015, which is incorporated by reference herein in its entirety.

### BACKGROUND OF THE INVENTION

### 1. Field of the Invention

The present invention relates to a method for making a lithographic printing plate by direct-to-plate recording comprising the step of image-wise deposition of a hydrophobic coating by means of microplasma onto a hydrophilic support or a support provided with a hydrophilic layer.

### 2. Description of the Related Art

Lithographic printing typically involves the use of a so-called printing master such as a printing plate which is mounted on a cylinder of a rotary printing press. The master carries a lithographic image on its surface and a print is obtained by applying ink to said image and then transferring the ink from the master onto a receiver material, which is typically paper. In conventional lithographic printing, ink as well as an aqueous fountain solution (also called dampening liquid) are supplied to the lithographic image which consists of oleophilic (or hydrophobic, i.e. ink-accepting, water-repelling) areas as well as hydrophilic (or oleophobic, i.e. water-accepting, ink-repelling) areas. In so-called driographic printing, the lithographic image consists of ink-accepting and ink-abhesive areas and during driographic printing, only ink is supplied to the master.

Lithographic printing masters are generally obtained by the image-wise exposure and processing of an imaging material called plate precursor. The coating of the precursor is exposed image-wise to heat or light, typically by means of a digitally modulated exposure device such as a laser, which triggers a (physico-)chemical process, such as ablation, polymerization, insolubilization by cross-linking of a polymer or by particle coagulation of a thermoplastic polymer latex, solubilization by the destruction of intermolecular interactions or by increasing the penetrability of a development barrier layer.

The most popular plate precursors require wet processing since the exposure produces a difference of solubility or of rate of dissolution in a developer between the exposed and the non-exposed areas of the coating. In positive working plate precursors, the exposed areas of the coating dissolve in the developer while the non-exposed areas remain resistant to the developer. In negative working plate precursors, the non-exposed areas of the coating dissolve in the developer while the exposed areas remain resistant to the developer. Most plate precursors contain a hydrophobic coating on a hydrophilic support, so that the areas which remain resistant to the developer define the ink-accepting, printing areas of the plate while the hydrophilic support is revealed by the dissolution of the coating in the developer at the non-printing areas.

Some thermal processes which enable platemaking without wet processing are for example processes based on a heat-induced hydrophilic/oleophilic conversion of one or more layers of the coating so that in the exposed areas a different affinity towards ink or fountain is created than at the surface of the unexposed coating. These so called “switchable polymer systems” are based on different working mechanism such as for example masking/demasking of a polar group or destruction/generation of charge. However, the main problems occurring for printing plates based on such a chemical switching reaction is insufficient physical robustness of the image parts and insufficient resistance to toning.

Other plate precursors capable of producing a lithographic image immediately after exposure without wet processing are for example based on ablation of one or more layers of the coating. In the exposed areas the surface of an underlying layer is revealed which has a different affinity towards ink or fountain than the surface of the unexposed coating.

U.S. Pat. No. 5,062,364 discloses a method of imaging on press a printing plate comprising a metal top layer by exposing its surface to plasma jet discharges whereby the metal top layer is removed and a different affinity for ink and/or water is created.

WO 2005/108076 discloses a lithographic printing member that includes an imaging layer and a plasma-polymerized hydrocarbon plasma top-layer that facilitates selective removal of the imaging layer by ablation with a low power laser.

A major problem associated with most ablative plate precursors, however, is the generation of ablation debris which may contaminate the electronics and optics of the exposure device and which needs to be removed from the plate by wiping it with a cleaning solvent so that ablative plates are often not truly processless.

It remains a challenge in the art to develop truly processless printing plate precursors which prevent the problems associated with plate precursors that are based on ablation and/or on a switching reaction.

U.S. Pat. No. 8,702,902 discloses an apparatus for generating a plasma discharge for patterning the surface of a substrate comprising a first and a second electrode having a discharge portion, a high voltage source for generating a high voltage difference between the first and the second electrode, and positioning means for selectively positioning the electrodes with respect to the substrate, wherein the positioning means can selectively position the electrodes in order to either prevent or allow plasma discharge at the high voltage difference.

### SUMMARY OF THE INVENTION

Preferred embodiments of the present invention provide a non-ablative, truly processless lithographic printing plate. These advantages and benefits are realized by the method defined below, i.e. a method for making a lithographic printing plate by direct-to-plate recording comprising the step of image-wise applying a hydrophobic coating by means of microplasma deposition onto a hydrophilic support or a support which is provided with a hydrophilic layer. The method allows immediate mounting on-press of the printing plate after the deposition step without the need for a processing step which makes it an excellent method from an environmental point of view. Furthermore, the problems associated with an exposure and/or processing step, such as for example generation of ablation debris and/or insufficient clean-out, are avoided.

It was surprisingly found that the deposition of a hydrophobic coating by means of microplasma on a support having a hydrophilic surface or which is provided with a hydrophilic layer provides a printing plate ready to be mounted on press.

Specific features for preferred embodiments of the invention are set out below. Further advantages and embodiments of the present invention will become apparent from the following description and drawings.

### BRIEF DESCRIPTION OF THE DRAWINGS

FIG. 1 shows a schematic presentation of a preferred system for patterning a substrate by means of plasma deposition.

FIG. 2 shows patterns deposited by plasma deposition.

FIG. 3 shows the substrate after plasma deposition.

FIG. 4 shows page 100 after dry restart of the printing process.

FIG. 5 shows that, after removal from the press, the ink remains on the imaged parts.

### DETAILED DESCRIPTION OF THE PREFERRED EMBODIMENTS

Plasma may be referred to as the fourth state of matter. The term was introduced by Langmuir in 1929. Plasma is a partly ionized gas and can be defined as a quasi-neutral particle system in the form of gaseous or fluid-like mixtures of free electrons, ions, and radicals, and generally also containing neutral particles such as for example atoms and molecules. Plasmas are typically obtained when gases are excited into energetic states. The application of a strong electric field to a neutral gas ensures ionization in the gas volume and the created charged particles are accelerated in the applied electrical field. Especially the electrons are affected by the field due to their light mass and gain most energy. On collision between energetic electrons and neutral molecules, radicals are created which play an important role in the chemical activity of the plasma.

Plasma is thus a very reactive environment which makes several different interactions between plasma and a surface possible. Plasma can locally modify the wettability of the surface whereby a differentiation between ink accepting and ink repelling areas is created. Surface wettability can for example be increased by the introduction of polar functional groups to (inert) surfaces. Post-plasma rearrangements and/or reactions such as post-plasma oxidation and/or reorientation of the introduced polar groups are usually observed with plasma treatment. The driving force for such a surface adaptation is believed to be to minimize the interfacial energy.

The plasma may be generated under atmospheric conditions, or alternatively, it may be generated at reduced or elevated pressure. The final surface properties are a complex interplay between the type of substrate, the kind of gas(es), the processing parameters, storage time (aging) and/or storage conditions.

The plasma may be formed in air or in a gas comprising for example argon, oxygen, ammonia, nitrogen, helium or a mixture thereof. Precursors such as organosilicon compounds e.g. hexa-alkyldisiloxane such as hexamethyldisiloxane or hexa-ethyldisiloxane, hexa-alkyldisilane such as hexa-methyldisilane, hexa-ethyldisilane or (3-aminopropyl)trimethoxysilane, heptylamine, water, lineair hydroxycarbons such as alkanes, alkenes, alkynes, amines such as ethylamine, aniline, styrene, alcohols such as isopropanol, ethanol, methanol, halogenated hydroxycarbons such as CF4 and/or (meth)acrylates may be added to the gas or gas mixture. More information regarding these plasma's can be found in Nonthermal Plasma Technology as a Versatile Strategy for Polymeric Biomaterials Surface Modification: A Review, Tim Desmet et al., Biomacromolecules, Vol. 10, No. 9, 2009 pages 2351 to 2378, especially Tables 3 and 5.

In the art, three main categories of plasma reactions are distinguished: (i) plasma polymerization, (ii) direct treatment, and (iii) plasma etching/ablation. Depending on the process conditions such as for example vapour pressure, reaction time, type of substrate and/or temperature, one or a combination of these plasma reactions will occur.

Plasma polymerization or deposition involves the deposition of reactive fragments onto the substrate. Reactive fragments are formed when for example monomers or other substances containing are introduced in the gas phase plasma and initiate polymerisation in this plasma phase—i.e. plasma-state polymerization—and/or on the substrate after deposition. In this way, a coating can be formed onto the substrate. In addition, the coating and the substrate may be bombarded with ions from the plasma, and thus etching may occur simultaneously. Depending on the chemical nature of the monomers and/or substances used, this coating will possess different chemical and physical properties. For example, a hexane plasma will lead to hydrophobic coatings while an allylamine plasma will result in hydrophilic coatings.

Direct plasma treatment on the other hand is in general used to obtain more hydrophilic surfaces and involves using so-called “inert gases” such as He, Ar, O₂, NH₃, CO₂, CO and N₂ which do not lead to reactive intermediates. These gases will not form a polymerized coating on the surface but will create functional groups (O₂, NH₃, CO₂, CO and N₂) and/or radicals (He, Ar) which can subsequently react with chemical compounds such as for example polymers in order to achieve the desired surface properties.

In the current invention, it has been found that excellent printing plates can be obtained by image-wise applying a hydrophobic coating onto a support having a hydrophilic surface or a support provided with a hydrophilic layer, by means of atmospheric microplasma treatment and/or deposition. So-called microplasma is referred to herein as plasma generated for local treatment of substrates which is able to provide plasma discharges of less than 1 mm diameter. The concentration of active species near the surface of the support mainly depends on the distance between the support and the plasma source and on the lifetime of the active species. Plasma treatment causes radical reactions of the treated surface while electron and/or ion etching effects are preferably minimised and/or even avoided. The microplasma which results from dissociation reactions of gas molecules due to electron impacts which occur between electrodes, is able to selectively generate chemical reactive species and shows a remarkable stability toward arcing. The breakdown voltage required to discharge the microplasma mainly depends on the pressure of the microplasma and the electrode separation. When for example the electrodes are separated by less than 1 mm, the voltage required to initiate a discharge can be kept low, even at atmospheric pressure.

The microplasma is preferably formed in a gas such as for example argon, oxygen, ammonia, nitrogen, helium or mixtures thereof, including precursors such as organosilicon compounds, hydroxycarbons such as alkanes such as methane, ethane, propane, butane, pentane; alkenes such as ethene, propene, butene or pentene; alkynes such as ethyn, propyn, but-1-yn, but-2-yn, pentyn; amines such as ethylamine or heptylamine; aniline; alcohols such as isopropanol, ethanol, methanol; styrene and/or halogenated hydroxycarbons such as CF4 or tetrafluoroethhylene. These compounds may optionally be substituted by for example an alkyl group such as a methyl, ethyl, n-propyl, isopropyl; a halogen such as chloro, brome or iodo; an aryl group such as a phenyl group or naphthyl group; or aralkyl group such as a phenyl or naphthyl group including one, two, three or more C₁ to C₆-alkyl groups.

The organosilicon compounds are preferably alkyl- or arylsilanes or alkyl- or arylsiloxanes which contain —Si(R,R′)—O— wherein R and R′ are optionally substituted alkyl or aryl groups; for example hexa-alkyldisilane or hexa-alkyldisiloxane such as hexamethyl disilane, hexa-ethyl disilane, hexapropyl disilane, hexamethyl disiloxane, hexa-ethyl disiloxane and/or hexapropyl disiloxane or (3-aminopropyl)trimethoxysilane.

More preferably, the microplasma is formed in a gas including organosilicon compounds and/or alkanes. Most preferably, the microplasma is formed in a gas including organosilicon compounds. The organosilicon compounds are described above.

In the current invention, the plasma forms a pattern on a hydrophilic surface of a substrate and is preferably created by a device for generating a plasma discharge comprising at least a first electrode having a first discharge portion and at least a second electrode having a second discharge portion, a high voltage source for generating a high voltage difference between the first and the second electrode and, preferably, positioning means for independently positioning the electrodes with respect to the support. The positioning means are arranged for selectively positioning the electrodes either in a position in which the distance between the discharge portion and the surface is sufficiently small to support the plasma discharge at the high voltage difference, or in a position wherein the distance between the discharge portion and the surface is sufficiently large to prevent microplasma discharge at the high voltage difference. Alternatively, microplasma-discharge may be provoked by increasing the voltage while maintaining the distance between the discharge portion and the surface. Preferably, the positioning means are arranged for moving the first electrode in a direction towards and away from the second electrode. Therefore, the microplasma can be switched on or off by placing the first electrode in the first or second position respectively using the positioning means. More details concerning such a microplasma discharge device can be found in U.S. Pat. No. 8,702,902.

The image-wise deposition of the hydrophobic coating by means of microplasma is preferably generated at a gas pressure below 2 bar using printing heads having a printing frequency of about 400 Hertz per nozzle. However, it is up to the skilled person to optimise the applied parameters such as pressure, temperature, reaction time, voltage and distance between cathode and anode. The hydrophobic coating induces an increased contact angle for water compared to the uncoated areas of the support. The contact angle is defined as the angle between the tangent of the water droplet at the contact point with the solid and the base of this droplet. In the method of the present invention, the increase of the contact angle for water is preferably higher than 20°, more preferably higher than 25° and most preferably higher than 40°.

The image-wise deposition of the hydrophobic coating onto the hydrophilic support or the support provided with a hydrophilic layer by means of microplasma may be carried out before the printing plate is mounted on press, or alternatively, the image-wise deposition may be carried out on press whereby the device which generates the microplasma is mounted on a printing press.

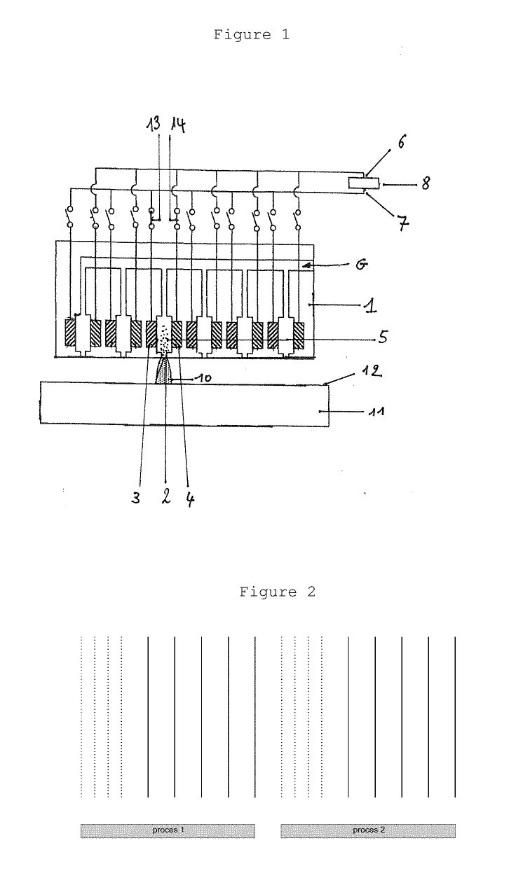

FIG. 1 shows a preferred device suitable for generating microplasma discharge for direct patterning a support e.g. deposition of matter onto the surface and/or changing the surface property such as wettability. The microplasma source (1) comprises a plurality of nozzles (2). Per nozzle, two piezo-electric elements (3 and 4) are positioned adjacent to an internal gas chamber (5) and are connected to the terminals (6 and 7) of the high voltage source (8), respectively. When a high voltage difference is maintained between the piezo-electric elements (3 and 4) they act as the first and second electrode.

The device may be operated as follows. A gas flow is fed into the microplasma source (1) as indicated with arrow G. When the surface (12) of the substrate (11) is to be selectively treated with a plasma, the location where the surface 12 is to be treated is determined. The nozzle (2) and the associated first electrode (3) and second electrode (4) closest to the determined location on the surface are selected.

Initially the first electrode (3) and the second electrode (4) may be disconnected from the high voltage source (8) so that no plasma discharge is generated. These electrodes may be connected to the high voltage source (8) via switches (13) and (14) respectively. Then, in the region between the electrodes, the plasma (10) will be generated. Due to the velocity of the gas flow, the plasma (10) will be ejected from the nozzle (2) towards the surface (12) of the substrate. The microplasma source (1) may be scanned along the surface (12).

As microplasma source a conventional and/or adapted inkjet head or other micro-sized devices may be used. For example, one of the electrodes may be formed by an electrically conducting nozzle plate surrounding the nozzle or an electrical heating resistor may form an electrode for generating the plasma. Other configurations where for example the electrodes are needle like and comprise one or a plurality of needle-like electrodes, plateshaped or other designs are possible. The needle-like electrodes may be simple metal rods or needles and nano-structured or micro-structured electrodes may be used. The nano-structured or micro-structured electrodes may enhance the field emission, can be used to confine the plasma in a small area hereby increase the resolution of the device, and influence the characteristics and inception voltage of the plasma. These nano-/micro-structured electrodes may e.g. be produced by laser deposition or ablation of a needle tip, dedicated crystal growth at the needle tip or by using carbon nanotubes.

The lithographic printing plate precursor used in the present invention comprises a support which has a hydrophilic surface or which is provided with a hydrophilic layer. The support may be a sheet-like material such as a plate or it may be a cylindrical element such as a sleeve which can be slid around a print cylinder of a printing press. Preferably, the support is a metal support such as aluminium or stainless steel. The support can also be a laminate comprising an aluminium foil and a plastic layer, e.g. polyester film.

A preferred lithographic support is an electrochemically grained and anodized aluminium support. The aluminium support has usually a thickness of about 0.1-0.6 mm. The aluminium is preferably grained by electrochemical graining, and anodized by means of anodizing techniques employing phosphoric acid or a sulphuric acid/phosphoric acid mixture. Methods of both graining and anodization of aluminium are very well known in the art.

By graining (or roughening) the aluminium support, its wetting characteristics are improved. By varying the type and/or concentration of the electrolyte and the applied voltage in the graining step, different type of grains can be obtained. The surface roughness is often expressed as arithmetical mean center-line roughness Ra (ISO 4287/1 or DIN 4762) and may vary between 0.05 and 1.5 μm. The aluminium substrate of the current invention has preferably an Ra value below 0.45 μm, more preferably below 0.40 μm and most preferably below 0.30 μm. The lower limit of the Ra value is preferably about 0.1 μm. More details concerning the preferred Ra values of the surface of the grained and anodized aluminium support are described in EP 1 356 926.

By anodising the aluminium support, its abrasion resistance and hydrophilic nature are improved. The microstructure as well as the thickness of the Al₂O₃ layer are determined by the anodising step, the anodic weight (g/m² Al₂O₃ formed on the aluminium surface) varies between 1 and 8 g/m². The anodic weight is preferably ≥3 g/m², more preferably ≥3.5 g/m² and most preferably ≥4.0 g/m².

The grained and anodized aluminium support may be subject to a so-called post-anodic treatment to improve the hydrophilic properties of its surface. For example, the aluminium support may be silicated by treating its surface with a sodium silicate solution at elevated temperature, e.g. 95° C. Alternatively, a phosphate treatment may be applied which involves treating the aluminium oxide surface with a phosphate solution that may further contain an inorganic fluoride. Further, the aluminium oxide surface may be rinsed with a citric acid or citrate solution. This treatment may be carried out at room temperature or may be carried out at a slightly elevated temperature of about 30 to 50° C. A further interesting treatment involves rinsing the aluminium oxide surface with a bicarbonate solution. Still further, the aluminium oxide surface may be treated with polyvinylphosphonic acid, polyvinylmethylphosphonic acid, phosphoric acid esters of polyvinyl alcohol, polyvinylsulphonic acid, polyvinylbenzenesulphonic acid, sulphuric acid esters of polyvinyl alcohol, and acetals of polyvinyl alcohols formed by reaction with a sulphonated aliphatic aldehyde.

A particularly preferred support is a non-conductive, non-metal support such as a flexible support, which may be provided with a hydrophilic layer, hereinafter called ‘base layer’. The flexible support is e.g. paper, plastic film or aluminium. Preferred examples of plastic film are polyethylene terephthalate film, polyethylene naphthalate film, cellulose acetate film, polystyrene film, polycarbonate film, polyurethanes, acrylic polymers, polyamide polymers, phenolic polymers, polysulfones and polystyrenes. Preferably, the plastic film is selected from polyethylene terephthalate film, polyethylene naphthalate film or cellulose acetate film. Most preferred is polyethylene terephthalate film. The plastic film support may be opaque or transparent.

The base layer is preferably a cross-linked hydrophilic layer obtained from a hydrophilic binder cross-linked with a hardening agent such as formaldehyde, glyoxal, polyisocyanate or a hydrolyzed tetra-alkylorthosilicate such as tetra-methylorthosilicate or tetra-ethylorthosilicate. A hydrolyzed tetra-alkylorthosilicate is particularly preferred. The thickness of the hydrophilic base layer may vary in the range of 0.2 to 25 μm and is preferably 1 to 10 μm.

The hydrophilic binder for use in the base layer is e.g. a hydrophilic (co)polymer such as homopolymers and copolymers of vinyl alcohol, acrylamide, methylol acrylamide, methylol methacrylamide, acrylate acid, methacrylate acid, hydroxyethyl acrylate, hydroxyethyl methacrylate or maleic anhydride/vinylmethylether copolymers. The hydrophilicity of the (co)polymer or (co)polymer mixture used is preferably the same as or higher than the hydrophilicity of polyvinyl acetate hydrolyzed to at least an extent of 60% by weight, preferably 80% by weight.

The amount of hardening agent, in particular tetra-alkyl orthosilicate such as tetra-methylorthosilicate or tetra-ethylorthosilicate, is preferably at least 0.2 parts per part by weight of hydrophilic binder, more preferably between 0.5 and 5 parts by weight, most preferably between 1 parts and 3 parts by weight.

The hydrophilic base layer may also contain gelatin as hydrophilic colloid binder. Mixtures of different gelatins with different viscosities can be used to adjust the rheological properties of the layer. The hydrophilic layer is coated preferably at a pH value near the isoelectric point of the gelatin. Gelatin can be replaced in part or integrally by synthetic, semi-synthetic, or natural polymers. Synthetic substitutes for gelatin are e.g. polyvinyl alcohol, poly-N-vinyl pyrrolidone, polyvinyl imidazole, polyvinyl pyrazole, polyacrylamide, polyacrylic acid, and derivatives thereof, in particular copolymers thereof. Natural substitutes for gelatin are e.g. other proteins such as zein, albumin and casein, cellulose, saccharides, starch, and alginates. In general, the semi-synthetic substitutes for gelatin are modified natural products e.g. gelatin derivatives obtained by conversion of gelatin with alkylating or acylating agents or by grafting of polymerizable monomers on gelatin, and cellulose derivatives such as hydroxyalkyl cellulose, carboxymethyl cellulose, phthaloyl cellulose, and cellulose sulphates.

The hydrophilic layer based on gelatin can be hardened with hardening agents such as epoxides, ethylenimines, vinylsulfons e.g. 1,3-vinylsulphonyl-2-propanol, chromium salts e.g. chromium acetate and chromium alum, aldehydes e.g. formaldehyde, glyoxal, and glutaraldehyde, N-methylol compounds e.g. dimethylolurea and methyloldimethylhydantoin, dioxan derivatives e.g. 2,3-dihydroxy-dioxan, active vinyl compounds e.g. 1,3,5-triacryloyl-hexahydro-s-triazine, active halogen compounds e.g. 2,4-dichloro-6-hydroxy-s-triazine, and mucohalogenic acids e.g. mucochloric acid and mucophenoxychloric acid, and/or combinations thereof. The aldehyde hardening agents are preferred. The binders can also be hardened with fast-reacting hardeners such as carbamoylpyridinium salts of the type, described in U.S. Pat. No. 4,063,952. The hardening agents can be used in wide concentration range but are preferably used in an amount of 4% to 7% by weight of the hydrophilic colloid.

The hydrophilic base layer may also contain substances that increase the mechanical strength and the porosity of the layer. For this purpose colloidal silica may be used. The colloidal silica employed may be in the form of any commercially available water dispersion of colloidal silica for example having an average particle size up to 40 nm, e.g. 20 nm. In addition inert particles of larger size than the colloidal silica may be added e.g. silica prepared according to Stöber as described in J. Colloid and Interface Sci., Vol. 26, 1968, pages 62 to 69 or alumina particles or particles having an average diameter of at least 100 nm which are particles of titanium dioxide or other heavy metal oxides. By incorporating these particles the surface of the hydrophilic base layer is given a uniform rough texture consisting of microscopic hills and valleys, which serve as storage places for water in background areas.

Particular examples of suitable hydrophilic base layers for use in accordance with the present invention are disclosed in EP 1 025 992, EP 601 240, GB 1 419 512 and U.S. Pat. No. 4,284,705.

Microplasma may be used to locally oxidise the metal sheet whereby hydrophilic domains onto the metal layer are obtained.

According to the present invention, there is also provided a method of printing including the steps of mounting the printing plate on a printing press and supplying ink and or fountain.

The printing plates can be used for conventional, so-called wet offset printing, in which ink and an aqueous dampening liquid are supplied to the plate, or alternatively, for driographic or waterless printing where the non image areas are sufficient ink-repelling so that no water is needed to produce prints. Another suitable printing method uses so-called single-fluid ink without a dampening liquid. Suitable single-fluid inks have been described in U.S. Pat. No. 4,045,232; U.S. Pat. No. 4,981,517 and U.S. Pat. No. 6,140,392. In a most preferred embodiment, the single-fluid ink comprises an ink phase, also called the hydrophobic or oleophilic phase, and a polyol phase as described in WO 00/32705.

### Examples

While the present invention will hereinafter be described in connection with preferred embodiments thereof, it will be understood that it is not intended to limit the invention to those embodiments. Unless otherwise specified, all compounds and solvents used in the Examples are readily available from fine chemical suppliers such as Acros or Aldrich.

### 1. Preparation of the Lithographic Base.

To 440 g of a dispersion containing 21.5% Ti02 (average particle size 0.3 to 0.5 um) and 2.5% polyvinyl alcohol in deionized water were subsequently added, while stirring, 250 g of a 5% polyvinyl alcohol solution in water, 105 g of a hydrolyzed 22% tetramethyl orthosilicate (TMOS) emulsion in water and 22 g of a 10% solution of a wetting agent. To this mixture was then added 183 g of deionized water and the pH was adjusted to pH=4.

The thus obtained dispersion was coated on a polyethyleneterephthalate film support at a wet coating thickness of 50 g/m², dried at 30° C. and subsequently hardened by subjecting it to a temperature of 60° C. for 1 week.

### 2. Plasma Deposition

The obtained polyethyleneterephtalate support provided with the layer of polyvinylalcohol crosslinked with tetramethyl orthosilicate was treated by means of plasma-printing deposition using plasma including the colourless liquid hexamethyl disilane. A specified pattern of points and lines was deposited by means of the plasma treatment for each of the treatment times: process 1 (15 minutes) and process 2 (60 minutes): see FIG. 2). A plasma printing station, commercially available from Innophysics BV (The Netherlands) was used.

After the plasma-deposition treatment, no visual contrast between the image areas (parts with plasma deposition) and the non-image areas was observed (see FIG. 3).

### 3. Contact Angle Measurement

The contact angle is defined as the angle between the tangent of the water droplet at the contact point with the solid and the base of this droplet.

The contact angle with water was measured after at least 48 h after the plasma treatment in each quadrant; i.e. 4 measurements, utilizing a Fibro DAT1100 equipment (trademark of FIBRO system AB). As a reference, the contact angle for water of on an untreated PET-TMOS substrate was determined.

The results of the contact angle measurements are given in Table 1.

TABLE 1
contact angle measurements

| | | Mean contact |
|---|---|---|
| Printing plate | Plasma deposition | angle ° |
| Reference | untreated | 36.0 |
| Inventive PP | treated with | 94.0 |
| | hexamethyl disilane | |
| | containing plasma | |

The results in Table 1 show a significant increase in contact angle for the plasma treated printing plate which indicate a hydrophilic to hydrophobic conversion of the surface of the treated printing plate. The contact angle of a hydrophobic surface is defined as 80.

### 4. Printing Test

After the plasma deposition, the obtained printing plate was used to print: directly after treatment it was mounted on a Heidelberg GT052 printing press (available from Heidelberger Druckmaschinen AG) equipped with a Dahlgren dampening system and a print job was started without carrying out any processing or rinsing step. During the printing, Van Son 167 ink (trademark of Van Son Inktfabrieken N.V.) was used and Rotamatic fountain solution (available from Unigrafica GmbH). A compressible rubber blanket was used and the prints were made on 80 g offset paper.

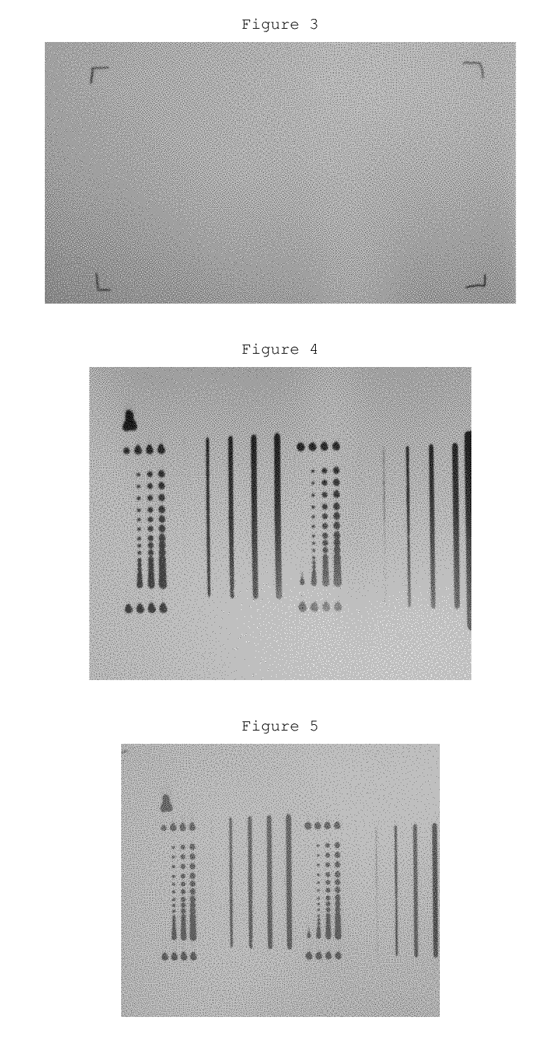

The imaged parts of the printing plate show an excellent ink-uptake and/or oleophilic properties from page 1 and a good resolution is obtained. This is illustrated in FIG. 4 where page 100 after a dry restart is shown. After removal from the press, the ink remains on the imaged parts and is shown in FIG. 5.

1-10. (canceled)

11. A method for making a lithographic printing plate comprising the step of:
image-wise depositing a hydrophobic coating with a microplasma onto a hydrophilic support or a support provided with a hydrophilic layer.

12. The method according to claim 11, wherein the hydrophobic coating includes optionally substituted hydrocarbons, organosilicon compounds, amines, or aniline and/or styrene.

13. The method according to claim 11, wherein the hydrophobic coating includes hydrocarbons substituted with chloro, bromo, or iodo.

14. The method according to claim 12, wherein the hydrophobic coating includes hydrocarbons substituted with chloro, bromo, or iodo.

15. The method according to claim 11, wherein the support is a plastic film selected from polyethylene terephthalate film, polyethylene naphthalate film, cellulose acetate film, polystyrene film, polycarbonate film, polyurethanes, acrylic polymers, polyamide polymers, phenolic polymers, polysulfones, and polystyrenes.

16. The method according to claim 12, wherein the support is a plastic film selected from polyethylene terephthalate film, polyethylene naphthalate film, cellulose acetate film, polystyrene film, polycarbonate film, polyurethanes, acrylic polymers, polyamide polymers, phenolic polymers, polysulfones, and polystyrenes.

17. The method according to claim 11, wherein the hydrophilic layer is a cross-linked hydrophilic layer selected from a hydrophilic binder cross-linked with a hardening agent selected from formaldehyde, glyoxal, polyisocyanate, and hydrolyzed tetra-alkylorthosilicate.

18. The method according to claim 12, wherein the hydrophilic layer is a cross-linked hydrophilic layer selected from a hydrophilic binder cross-linked with a hardening agent selected from formaldehyde, glyoxal, polyisocyanate, and hydrolyzed tetra-alkylorthosilicate.

19. The method according to claim 13, wherein the hydrophilic layer is a cross-linked hydrophilic layer selected from a hydrophilic binder cross-linked with a hardening agent selected from formaldehyde, glyoxal, polyisocyanate, and hydrolyzed tetra-alkylorthosilicate.

20. The method according to claim 15, wherein the hydrophilic layer is a cross-linked hydrophilic layer selected from a hydrophilic binder cross-linked with a hardening agent selected from formaldehyde, glyoxal, polyisocyanate, and hydrolyzed tetra-alkylorthosilicate.

21. The method according to claim 11, wherein the hydrophilic support is selected from grained aluminum and anodized aluminum.

22. The method according to claim 12, wherein the hydrophilic support is selected from grained aluminum and anodized aluminum.

23. The method according to claim 11, wherein areas of the support which are provided with the hydrophobic coating have an increased contact angle for water compared to uncoated areas of the support which are not provided with the hydrophobic coating.

24. The method according to claim 12, wherein areas of the support which are provided with the hydrophobic coating have an increased contact angle for water compared to uncoated areas of the support which are not provided with the hydrophobic coating.

25. The method according to claim 15, wherein areas of the support which are provided with the hydrophobic coating have an increased contact angle for water compared to uncoated areas of the support which are not provided with the hydrophobic coating.

26. The method according to claim 11, wherein the step of image-wise depositing the hydrophobic coating with the microplasma includes:
generating a plasma discharge with a device including at least two electrodes, each of the at least two electrodes including a discharge portion, a high voltage source, and a positioner to position the at least two electrodes relative to the support.

27. The method according to claim 12, wherein the step of image-wise depositing the hydrophobic coating with the microplasma includes:
generating a plasma discharge with a device including at least two electrodes, each of the at least two electrodes including a discharge portion, a high voltage source, and a positioner to position the at least two electrodes relative to the support.

28. The method according to claim 13, wherein the step of image-wise depositing the hydrophobic coating with the microplasma includes:
generating a plasma discharge with a device including at least two electrodes, each of the at least two electrodes including a discharge portion, a high voltage source, and a positioner to position the at least two electrodes relative to the support.

29. The method according to claim 27, wherein the device that generates the plasma discharge is an adapted inkjet print head.

30. The method according to claim 27, wherein the device that generates the plasma discharge is mounted in a printing press.
